(19) United States
(12) Patent Application Publication
(10) Pub. No.: US 2024/0143693 A1
(43) Pub. Date: May 2, 2024

(54) DECODING ADDITIVE SUPERPOSITION OF VECTORS

(71) Applicant: INTERNATIONAL BUSINESS MACHINES CORPORATION, ARMONK, NY (US)

(72) Inventors: Zuzanna Dominika Domitrz, Torun (PL); Michael Andreas Hersche, Zurich (CH); Kumudu Geethan Karunaratne, Zurich (CH); Abu Sebastian, Adliswil (CH); Abbas Rahimi, Zurich (CH)

(21) Appl. No.: 17/978,348

(22) Filed: Nov. 1, 2022

(51) Int. Cl. G06F 9/30

(52) U.S. Cl. CPC G06F 9/30036; G06F 9/30145

(57) ABSTRACT

A composite vector is received. A first candidate component vector is generated and evaluated. The first candidate component vector is selected, based on the evaluating, as an accurate component vector. The first candidate component vector is unbundled from the composite vector. The unbundling results in a first reduced vector.

### BACKGROUND

The systems and methods of the present disclosure relate to high-dimensional computing.

High-dimensional (HD) computing refers to representing data as vectors with high dimensionality (e.g., vectors with more than three elements). As an example, a vector in three-dimensional space may be [x, y, z], such as [2, 4, 3]. One approach to HD computing utilizes Vector Symbolic Architectures (VSAs), which involve superposing data vectors into a single high-dimensional vector, allowing for various operations to be performed on the resulting data structure.

### SUMMARY

Some embodiments of the present disclosure can be illustrated as a method. The method includes receiving a composite vector and generating a first candidate component vector. The method further includes evaluating the first candidate component vector. The method further includes selecting, based on the evaluating, the first candidate component vector as an accurate component vector. The method also includes unbundling the first candidate component vector from the composite vector, resulting in a first reduced vector.

Some embodiments of the present disclosure can also be illustrated as a system. The system comprises a memory and a central processing unit coupled to the memory. The central processing unit is configured to perform the steps of the method summarized above.

Some embodiments of the present disclosure can also be illustrated as a second method. The method includes inputting a composite vector into a resonator circuit. The method also includes generating a set of estimate code vectors. The method also includes creating an unbound code vector from the composite vector for a particular estimate code vector in the set of estimate code vectors. The method also includes determining that a similarity between the unbound code vector and a set of actual code vectors is above a similarity threshold. The method also include includes binding, based on the determining, the unbound code vector with a set of other unbound code vectors, resulting in an accurate component vector. The method also includes unbundling the accurate component vector from the composite vector.

Some embodiments of the present disclosure can also be illustrated as a computer program product comprising a computer readable storage medium having program instructions embodied therewith, the program instructions executable by a computer to cause the computer to perform the method discussed above.

Some embodiments of the present disclosure can be illustrated as a system. The system may comprise memory and a central processing unit (CPU). The CPU may be configured to execute instructions to perform the method discussed above.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Features and advantages of various embodiments of the claimed subject matter will become apparent as the following Detailed Description proceeds, and upon reference to the drawings, in which like numerals indicate like parts, and in which:

FIG. 1 is a high-level method 100 of identifying a component vector of a query vector, consistent with several embodiments of the present disclosure.

FIG. 2 is a high-level method 200 of reducing a query to its component vectors, consistent with several embodiments of the present disclosure.

FIG. 3A depicts a block diagram depicting an example decoding process at a stage of generating multiple candidate component vectors, consistent with several embodiments of the present disclosure.

FIG. 3B depicts the block diagram depicting the example decoding process at a stage of selecting a component vector from various candidates, consistent with several embodiments of the present disclosure.

FIG. 3C depicts the block diagram depicting the example decoding process at a stage of subtracting the selected component vector, consistent with several embodiments of the present disclosure.

FIG. 3D depicts the block diagram depicting the example decoding process at a stage of generating further candidate component vectors, consistent with several embodiments of the present disclosure.

FIG. 4 illustrates a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to systems and methods for parallel decoding superposition of vectors. More particular aspects relate to systems and methods to receive a high-dimensional input vector, generate multiple candidate component vectors, select one of the candidate component vectors, and reduce the input vector based on the selected component vector.

High-dimensional (HD) computing refers to representing data as vectors with high dimensionality. For example, a vector used in high-dimensional computing can be a 1×500 vector, a 1×1000 vector, etc. HD computing can be particularly useful in combination with various machine learning techniques, such as neural networks. In order to be utilized in HD computing, a neural network may be trained based on a “codebook.” As an example, an image classifier may be configured to analyze an input image and detect various objects depicted in the image. As part of this process, the image classifier may generate a high-dimensional vector based on the image. The HD vector generated by the neural network may be similar to a combination of several other vectors, referred to herein as “component” vectors, some or all of which correspond to objects in the image. In turn, each component vector may be a combination of several codebook vectors (or “code vectors”), where each code vector corresponds to a feature of an object (such as its color, shape, position, etc.).

The neural network may be trained using one or more “codebooks,” which are collections of code vectors generated to correspond to specific features. For example, an image classifier whose output is fed into a system consistent with the present disclosure may be trained using a “color” codebook including ten color code vectors, where a first color code vector may represent “blue,” a second color code vector may represent “green,” and so on. The classifier may be trained based on several codebooks for different kinds of features, such as a positional codebook. In some embodiments, for example, the vectors of a first positional codebook may represent position of an object in a first dimension (e.g., a “left” vector, a “right” vector, and a “middle” vector) and the vectors of a second positional codebook may represent position of an object in a second dimension (e.g., a “top” vector, a “bottom” vector, and a “center” vector). In some embodiments, the vectors of a positional codebook may represent position of an object in multiple dimensions (e.g., a “top-left” vector and a “bottom-middle” vector).

An object in an image may be represented as a binding of code vectors that describe different properties of that object. “Binding” may refer to, for example, combining integer vectors in a circular convolution operation or combining binary vectors in an XOR or multiplication operation. These code vectors may be similar to, but typically not identical to, code vectors that describe those same properties in relevant codebooks. For example, a vector of a circular object with a reddish hue may be represented as a binding of a first vector that describes the circular shape of the object and a second vector that describes the reddish hue of the object. In this example, the first vector may be similar to, but not identical to, a “circle” vector in a shape codebook and the second vector may be similar to, but not identical to, a “red” vector in a color codebook.

Similarly, an entire image may be represented as a superposition of object vectors (i.e., component vectors) that correspond to various objects in the image. In some use cases, a classifier model may be trained to generate a single vector that represents the superposition of those object vectors. This single vector may, therefore, describe the image by describing the objects in the image. Although the single vector generated in this fashion is an output of the classifier, the vector is used as input to systems and methods consistent with the present disclosure. For this reason, a single such vector that describes an image is generally referred to as an “initial query vector,” “query vector” or “input vector.”

As an illustrative example, an example color codebook may include a “blue” code vector and a “green” code vector. An example positional codebook may include a “center left” vector and a “bottom right” vector. Given an image with a green object in the bottom right, a vector that describes the green object may be a binding (a type of combination) of the “green” vector and the “bottom right” vector. If the image also includes a different, blue object in the bottom right, this may be represented by a second binding of the “blue” vector and the “bottom right” vector. These combinations may themselves be superimposed to form a vector that describes the image of both objects. Additional codebooks may be implemented to account for features such as shape, orientation, size, etc. For example, a “shape” codebook may include a “triangle shape” vector, a “numeral 6 shape” vector, and so on. However, in some instances, the features described above may actually be represented by multiple codebooks. As an example, in some instances, multiple positional codebooks may be utilized (such as a “horizontal” codebook and a “vertical” codebook).

Notably, this combination process may not necessarily represent how the neural network actually generates a query vector. The neural network may be trained (e.g., weights of nodes of the network may be adjusted) until the neural network produces outputs similar to the codebook-based process described above. As a result of this training, a query vector that is output by the neural network may resemble a vector that was generated by combining code vectors from codebooks that describe the properties of objects within the image. For this reason, a system consistent with the present disclosure can be enabled to analyze a query vector and discover multiple component vectors that could be combined to form that query vector. This discovery process may be referred to as decoding the query vector.

The process of decoding an HD query vector that describes an image may be performed as a series of decoding steps, with each decode step identifying a component vector that is made up of a group of code vectors. This component vector may represent a particular object within the image. After a component vector is identified, that component vector can then be removed from the query vector, resulting in a second query vector. This second query vector may represent the image with the particular object removed. Another decoding step can then be performed on the second query vector, and so on until each component vector has been identified. As a simple example, a 3-dimensional query vector of [1, 2, 3] may undergo a first decoding step, identifying a first component vector of [0.5, 1, 1]. This first component vector can be subtracted from the query vector, resulting in a second query vector of [0.5, 1, 2] (as 1−0.5=0.5, 2−1=1, and 3−1=2). A second decoding step may be performed on this second query vector, identifying a second component vector of [0, 0, 4], which may similarly be subtracted from the second query vector, resulting in a third query vector of [0.5, 1, −2]. Additional decoding steps may be performed until an end condition is reached. In some instances, the end condition may be a preset limit of identified component vectors being reached (e.g., three or four). In some instances, the end condition may be detecting that the remaining query vector exceeds a similarity threshold to a single candidate component vector, which may indicate that the remaining query vector is likely a final component vector itself. In some embodiments, the end condition may be detecting that the remaining query vector is very similar to zero (e.g., [0, 0, 0.0001]).

As will be discussed below, several techniques exist for performing decoding steps on query vectors. While most such techniques begin with an initial query vector (e.g., a query vector that was output by a classifier), some techniques differ in how that initial query vector is analyzed and in the type of other vectors are produced in the decoding process. For example, some techniques produce reduced query vectors after an accurate component vector is identified and unbundled from the query vector. Some techniques create candidate component vectors that are then analyzed to identify component vectors. In some techniques, estimate code vectors may be unbound from these candidate component vectors, reduced query vectors, or initial query vectors. For the sake of understanding, a vector that can be expressed as a combination of multiple vectors are referred to herein as “composite vectors.” Thus, a composite vector may refer to an initial query vector, a reduced query vector, a component vector, or candidate component vector. Further, unbinding one or more code vectors from a “composite vector” may refer to unbinding those code vectors from an initial query vector, a reduced query vector, a candidate component vector, or component vector, depending on the surrounding context. Other techniques discussed herein that are described as being performed on a composite vector should be interpreted similarly.

Several techniques exist for performing decoding steps on query vectors. For example, a brute force approach can be utilized, essentially selecting random code vectors (one from each codebook), combining them together to form a candidate component vector, and comparing the candidate component vector to the query vector. This comparison can be quantified in terms of similarity, which is a representation of how close each element of the two vectors are to one another. For example, 100% similarity implies that the candidate component vector and the query vector are identical. However, a candidate component vector may be 100% similar to a query vector if the query vector describes an image with only one shape that is identical to the shape described by the candidate component vector. In practice, there may be other shapes in the image described by the query vector and/or the shape described by the candidate component vector may not be identical to a shape in the image. Thus, in practice, the similarity between the query vector and candidate component vector may be compared to a predetermined similarity threshold. For example, if the similarity is above a predetermined 70% similarity threshold, then the candidate component vector may be considered a valid component vector of the query.

Notably, while the query vector is considered to be a superposition of multiple component vectors, in some instances the query vector may still be significantly similar to one of the candidate component vectors and dissimilar to most or even all other candidate component vectors. This is because the classifier that creates the candidate component vector was trained using the code vectors from the aforementioned codebooks, and these code vectors were created with a high degree of randomness and high dimensionality. Thus, each individual component vector that is represented by the query vector is also likely to exhibit a high degree of randomness and high dimensionality. For this reason, most component vectors, when superimposed into a query vector, are likely to cancel each other out as random noise. However, one or more candidate component vectors may, by chance, differ from and not be cancelled out by that noise. Any such candidate component vector would therefore retain a substantial similarity to the superposition (i.e., to the query vector). This way, component vectors can be identified based simply upon their similarity to the query vector.

Upon identifying a candidate component vector that exhibits sufficient similarity to the query vector (e.g., a similarity above a similarity threshold), the query vector can be modified by removing the similar candidate component vector from the query vector. The resulting reduced query vector could then be compared to the remaining set of candidate component vectors or a new set of candidate component vectors. The relative noise of the component vectors that are superimposed into the reduced vectors may be impacted by the subtraction of the similar candidate component vector. Specifically, the similarity of each remaining candidate component vector to the query vector relative to the similarity of other remaining candidate component vectors to the query vector may be increased. As a result, while most component vectors within the reduced query vectors may still cancel each other out as noise, a single component vector may maintain a high similarity to the reduced query vector. Further, a corresponding candidate component vector of that single component vector may be determined to be significantly similar to the reduced query vector. That corresponding candidate component vector may also be removed from the reduced query vector, allowing the process to repeat until all component vectors of the original query vector are identified and removed.

The above process of identifying and removing component vectors of a query vector may sometimes be referred to herein as decoding the query vector. As noted above, decoding a query vector may rely on a brute force method of creating all possible candidate component vectors from the code vectors in a set of codebooks and comparing those candidate component vectors to the query vector as discussed above. For example, a classifier may have been trained using two codebooks: position and shape. The position codebook may include 9 code vectors, whereas the shape codebook may include 26 code vectors. A brute force method using these codebooks may create 234 candidate component vectors that would represent each of the 26 shapes in each of the 9 positions. These 234 candidate component vectors may then each be compared the an original query vector, then a reduced query vector, and so on until all component vectors of the original query vector are identified and removed.

This brute force method of decoding a query vector may have good results in terms of accuracy, but may be very performance intensive and time consuming. Thus, in some use cases alternative decoding processes may be utilized. For example, a structure known as a “resonator” or “resonator circuit” can be utilized to perform decoding steps on a query vector.

In some instances, a resonator may more rapidly identify component vectors and associated code vectors from a query vector. This may take several forms. In some embodiments, a query vector may be input into a resonator. A set of estimate code vectors may then be created. Specifically, an estimate code vector may be created for each codebook by, for example, the resonator circuit averaging, within the resonator circuit, all the actual code vectors in that codebook. The query vector may then be processed by a resonator pathway for each estimate code vector. For example, for a “vertical position” estimate code vector pathway, the other estimate code vectors (e.g., the horizontal position estimate code vector, the shape estimate code vector) may then be unbound from the query vector.

In other embodiments, a resonator circuit may be used to decode a query vector (sometimes referred to herein as factorizing the query vector) after first creating one or more candidate component vectors that each may be processed through a resonator in place of the original query vector. These candidate component vectors may be created, for example, through random sampling or random sparsification. Once created, the candidate component vectors may each be processed by a resonator (in series by a single resonator or in parallel by multiple resonators) in place of the original query vector.

For example, the resonator circuit would then estimate a set of code vectors that could be incorporated into that estimated component vector. Then in a pathway for each estimated code vector, the resonator would unbind all other estimated code vectors from the estimated component vector to result in an unbound code vector. If these pathways were performed in parallel, this would create a set of unbound code vectors (one for each codebook). In other words, this set of unbound code vectors may contain 1 unbound code vector for each codebook on which the classifier that created the query vector was trained. For example, if a classifier that was trained using 5 codebooks (e.g., shape, size, color, vertical position, and horizontal position) produced a query vector, this process would result in 5 unbound code vectors.

Each unbound code vector can then be compared to the actual code vectors in the corresponding codebook, resulting in a similarity value for each code vector. Those similarity values can then be used to create a weighted combination of the code vectors in each codebook, resulting in a new estimate code vector for each codebook that represents a weighted average of the code vectors in that codebook. The new estimate code vectors can then be compared to the code vectors in the codebook again. If they are all sufficiently similar (e.g., above a resonator similarity threshold) to a code vector, then they likely represent the code vectors that make up an actual component vector of the original query vector. If they are not sufficiently similar (e.g., below a resonator similarity threshold), the new estimated code vectors can then be unbound from the composite vector that was originally input into the resonator pathway (i.e., the original query vector, the candidate component vector, or a reduced query vector), again in the appropriate combinations to result in a new set of unbound code vectors. Again, this new set of unbound code vectors may contain 1 unbound code vector per each codebook. The weighted-combination process can then be repeated.

In some embodiments, a query vector may be input into a resonator circuit, but a set of candidate component vectors may be created within the resonator circuit and analyzed in place of the query vector. For example, a resonator may, through random sampling or random sparsification, create a set of candidate component vectors, each of which is then placed into a resonator pathway for a codebook. In this pathway, a set of estimate code vectors for all codebooks except for the codebook that corresponds to the pathway may be unbound from each candidate component vector. The similarities between the resulting unbound vectors and code vector from the pathway's codebook may then be expressed (e.g., in an attention vector) and averaged, resulting in an average similarity for each code vector in the codebook.

In some use cases, the above process of factorizing a composite vector (e.g., an initial query vector, a reduced query vector, or a candidate component vector) using a resonator may be substantially more efficient (in terms of time and computing resources) than a brute force process. However, performing a decoding step (e.g., identifying one accurate component vector of a query vector) with a resonator relies upon estimating component and code vectors. For that reason, if a process of decoding using a resonator is limited to a set number of iterations or a time period, the decoding process may not be absolutely guaranteed to succeed in identifying the component vectors before that limited number of iterations has been performed or time period has expired.

Once the decoding process is complete, the various component vectors can be output to whatever system needed the data represented by the query vector. For example, in some instances, the query vector may be an output of a neural network trained to identify objects in an image. In such instances, once the query vector is decoded, the component vectors may be provided to a system configured to utilize the information regarding the identified objects (e.g., a user interface).

Notably, the decoding processes described above, either performed though brute force techniques or resonator circuits, do not necessarily result in identifying component vectors that are 100% identical to actual component vectors that may have been superimposed (also referred to as “bundled”) together to create the input query vector. Rather, in many use cases the component vectors that result from the decoding process need only be sufficiently accurate to reliably identify the properties of the object to which those component vectors correspond. For example, if a classifier outputs a query vector that represents the location and spelling of words on a hand-written document, the component and code vectors that are produced for each word may need only be sufficiently accurate to reliably identify the shape and location of each word on the document. This is accounted for by evaluating an accuracy of decoded terms.

Systems and methods consistent with the present disclosure advantageously enable improved decoding of query vectors by evaluating multiple valid candidate component vectors at every level of a decoding process. Systems and methods consistent with the present disclosure may evaluate several of these component vectors, referred to as “candidate” component vectors, and select one to unbundle from the query vector. This can be performed at each level of the decoding process.

The number of candidate component vectors evaluated at each level of the decoding process is referred to as a “width” of the decoding process. For example, a process of generating four candidate component vectors, identifying one (or more) of those four candidate component vectors as sufficiently likely to be an actual component vector of an input query vector, unbundling the one (or more) of those candidate component vectors from the query vector, resulting in a reduced query vector, may be referred to has having a width of four. This process may be repeated by generating a second group of four candidate component vectors, identifying one (or more), and unbundling that one (or more) vector from the reduced query vector. These two iterations together can be referred to as having a width of four and a depth of two. In this way, systems and methods consistent with the present disclosure can improve accuracy of query vector decoding, providing increased performance when utilized in conjunction with various HD computing neural networks.

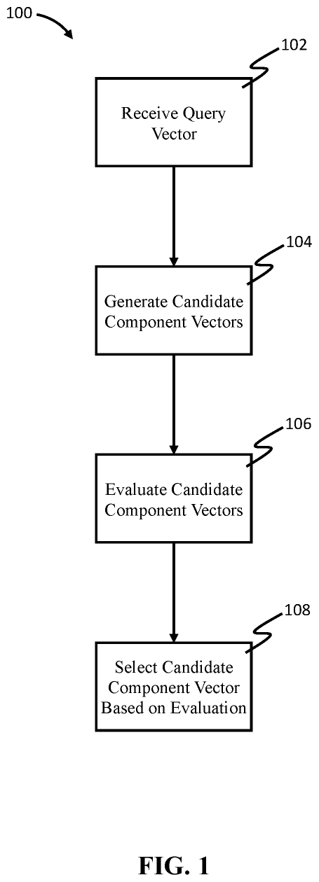

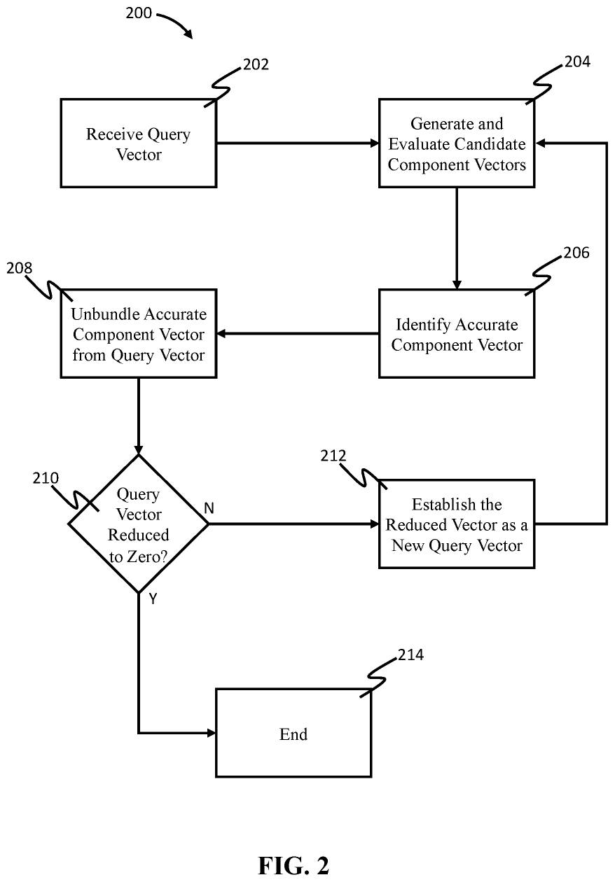

FIG. 1 is a high-level method 100 of identifying a component vector of a query vector, consistent with several embodiments of the present disclosure. Method 100 may be used to identify a component vector to unbundle from a query vector. As such, method 100 may represent one decoding step of a larger decoding process. For example, method 100 may be used as part of a process of analyzing a query vector that represents a set of objects in an image. The query vector may be composed of multiple component vectors that are superimposed together within the query vector. In this example, each component vector may represent a single object in the image, and may themselves be composed of multiple code vectors that are bound together and that represent the properties of the corresponding object. The component vector that is selected in method 100 may unbundled from the query vector, which may then be input into further iterations of method 100 until all component vectors have been unbundled from the query vector. As a result, method 100 may be performed multiple times during the process of decoding a query vector, as discussed in further detail below with reference to FIG. 2.

In some embodiments, method 100 may be used to analyze multiple candidate component vectors simultaneously, which may significantly decrease the overall time that is required to decode the query vector.

Method 100 comprises receiving a query vector at operation 102. In some instances, the query vector received at operation 102 may be an output from a neural network, such as an image classifier. For example, the neural network may be configured to receive an input image and generate a single query vector that represents objects that the neural network recognizes in the image. In some instances, the query vector received at operation 102 may have already undergone one or more decoding (also referred to as “reduction”) steps. In other words, the query vector received at operation 102 may not be the original input query vector, but a query vector that has already been reduced after a previously-identified component vector has been unbundled from it. However, until all component vectors have been unbundled from a query vector, the reduced query vector may still need to be reduced further, and method 100 may be performed to accomplish this.

Method 100 further comprises generating, at operation 104, multiple candidate component vectors from the query vector received via operation 102. These candidate component vectors may be created, for example, based on information that can be derived from the input query vector. In some embodiments, the method by which the candidate component vectors are generated may depend upon the format of the query vector.

For example, an input query vector may be a superposition of two component vectors, each of which are composed of a series of values that must be 1.0 or −1.0. If a value of at a particular position in the input query vector is 2.0 or −2.0, it can be concluded that the values of the component vectors at that particular position must be 1.0 or −1.0 respectively. However, if a value at a particular position in the input query vector is 0.0, then one component vector would exhibit 1.0 at that particular position and the other component vector would exhibit −1.0 at that particular position. Thus, in such an example, a set of candidate component vectors could be generated by first identifying all the positions with values that can be derived based on the value of the query vector at that position, then by randomly assigning a 1.0 or a −1.0 to all the remaining positions. This method of generating a candidate component vector may be referred to as “random tie breaking.”

As another example, an input query vector may take the form of a superposition of two sparse component vectors. A sparse vector may be composed of a series of sectors, each of which codes the value of a single digit and each of which may be composed of a set number of positions. In some applications, each sector may contain a single position with a value of 1.0 and the remaining positions of the sector may contain a value of 0.0. The value of a sector may be determined by the location of the 1.0 value within the sector. For example, a sector with a 1.0 value in the 3rd position may code a value of 2.0 because two positions in the sector precede the 1.0 value.

Thus, if a query vector represents two superimposed sparse component vectors, generation candidate component vectors may involve analyzing the input vector to determine whether the values of any sectors of each candidate component vector can be identified. In other words, set of a set of candidate component vectors could be generated by first identifying all the sectors with values that can be derived based on the value of the query vector at that position, then by randomly assigning one of the possible sectors in each of the remaining sector positions. This method of generating a candidate component vector may be referred to as “random sparsification.”

In some embodiments, generating a set of candidate component vectors may involve creating a set of all possible combinations of code vectors from the codebooks that were used to train the classifier that created the input query vector. For example, a classifier may have been trained using two codebooks: shape and position. The shape codebook may have two code vectors: a cat vector and a dog vector. The position vector may contain three code vectors: a high vector, a middle vector, and a low vector. In this example, a set of six candidate component vectors may be created by binding all the possible combinations of code vectors together: cat-high, cat-middle, cat-low, dog-high, dog-middle, dog-low. This method of generating candidate component vectors may be useful when decoding using a brute force method.

Regardless of the technique utilized, operation 104 generally provides multiple candidate component vectors which can be analyzed.

In some instances, near-zero values may be considered zero for purposes of operation 104. For example, if elements of the query vector are not integers, a value between −0.05 and 0.05 may be rounded to zero, and thus operation 104 may include setting corresponding elements in generated component vectors to tiebreaker values of −1 or 1.

The amount of candidate component vectors generated in operation 104 during a single iteration of method 100 (referred to as the “width” of the decoding process) may depend upon various constraints. For example, in some instances, processing budgets may dictate how many candidate component vectors can be evaluated simultaneously. In some instances, the number of candidate component vectors can be constrained by the input vector itself; as an example, as a query vector is reduced through repeated unbundlings of selected candidate component vectors from that query vector, the number of possible candidate component vectors that could be superimposed to create that reduced query vector may also decrease. Thus, a system performing method 100 may be configured to generate a limited number of candidate component vectors at operation 104. For example, in some instances, operation 104 may include generating four candidate component vectors (i.e., method 100 may be performed with a width of four), while in other instances, operation 104 may include generating twelve candidate component vectors (i.e., method 100 may be performed with a width of twelve).

Method 100 further comprises evaluating the candidate component vectors at operation 106. In general, evaluating a component vector may include determining whether a candidate component vector is likely to be superimposed into the query vector that was received in operation 102. This may be performed using several methods.

For example, when using a brute force approach, the candidate component vectors generated at operation 106 may have been generated by binding a code vector from each codebook that was used to train the model that created the initial query vector. These bound candidate component vectors could then be compared to the query vector that was received in operation 102. As discussed previously, while the query vector represents a superposition of multiple component vectors, most of those vectors may combine together in a way that resembles random noise, and thus may largely be cancelled out in the query vector. However, one or more component vectors may be disproportionately similar to the query vector in a way that does not resemble noise. For this reason, one of the candidate component vectors that were generated in operation 104 may also exhibit a similar level of disproportionate similarity to the query vector that was received in operation 102. For this reason, evaluation in operation 106 when using a brute force approach may include calculating the similarity (or relative similarity) of each generated candidate component vector to the query vector.

As another example, when using a resonator circuit, the candidate component vectors generated at operation 106 may have been created through random sampling or random sparsification. In this example, a set of estimate code vectors may be created for each candidate component vector that was generated in operation 104. These estimate code vectors may be duplicates of or based on the code vectors from the available codebooks. In some embodiments, for example, an estimate code vector for a codebook (e.g., the vertical position codebook) may actually be a code vector selected from that codebook. In some embodiments, an estimate code vector for a codebook may be a combination of some or all of the code vectors from that codebook (e.g., an average of all the vertical position code vectors in the vertical position codebook). The estimate code vectors may then be unbound from the corresponding candidate component vectors, resulting in an unbound vector for each codebook for each candidate component vector. For example, if a classifier were trained using a shape codebook, a position codebook, and a color codebook, a candidate component vector may be unbound into an unbound shape vector by unbinding the estimate position vector and the estimate color vector from the candidate component vector. That same candidate component vector may also be unbound into an unbound position vector by unbinding the estimate shape vector and the estimate color vector from the candidate component vector.

Each of these unbound code vectors could then be compared to each code vector in their corresponding codebook. In some embodiments, a similarity value could be created for each code vector in the codebook, and the code vectors in the codebook could then be weighted by those similarity values and combined with each other. This may, in effect, create an average code vector that is weighted based on the similarity of the code vectors to the corresponding unbound code vector.

In this example, this process would result in one weighted average code vector per codebook for each candidate component vector that was created in operation 104. In typical embodiments, the weighted average code vectors for each candidate component vector would then be compared to each of the code vectors from which they were combined. If all the weighted average code vectors for a candidate component vector is sufficiently similar to their corresponding code vectors (e.g., above a similarity threshold), that candidate component vector would be likely to be a component of the query vector that was received in operation 102. If, however, the set of weighted average code vectors for each candidate component vectors each contains at least one weighted average code vector that is not sufficiently similar to its corresponding code vector, then the evaluation process may continue. In this instance, the weighted average code vectors for each candidate component vector may be unbound from the corresponding candidate component vector in the same combinations as the previous unbinding step. This would result in a further set of unbound code vectors.

In some embodiments, the evaluation process in this example may proceed until all the weighted average code vectors in the set of weighted average code vectors corresponding to a candidate component vector are found to be sufficiently similar to their corresponding code vectors. In some embodiments, the evaluation process may repeat a maximum number of iterations (e.g., 10 iterations), at which point the candidate component vectors generated at operation 104 may be established as inaccurate, and further candidate component vectors may be generated and evaluated.

Regardless of the evaluation process, once a candidate component vector is identified to be accurate (e.g., sufficiently similar to the query vector, corresponding to a set of weighted average code vectors that all are sufficiently similar to their corresponding code vectors), that candidate component vector is selected at operation 108.

Upon selection of a candidate component vector, that candidate component vector may be subtracted from (e.g., unbundled from) the query vector that was received in operation 102. In some instances, this may result in a reduced query vector that represents a superposition of several other component vectors. In these instances, method 100 may be repeated for that reduced query vector. However, in some instances the selected candidate component vector may be so similar to the received query vector that the resulting reduced query vector is mostly (e.g., 99%) zeros. In that instance, the selected candidate component vector would likely be the last component vector of the query vector, and the initial query vector would be completely decoded into component vectors.

Of note and as discussed above, it is possible to perform methods of identifying a component vector of a query vector, similar to that of method 100, but without identifying candidate component vectors. For example, as is also discussed above, a query vector may be input directly into a resonator circuit rather than a candidate component vector being insert into a resonator circuit. In this example, estimate code vectors may be created within the resonator and be unbound from the query vector rather than from a candidate component vector. Such methods may resemble method 100, but operation 104 may be omitted and operation 106 may take the form of evaluating estimate code vectors. Operation 106 may be completed a set of code vectors can be identified such that the set contains a code vector for each codebook and each code vector in the set is above a threshold similarity to an actual code vector in a codebook. Operation 108 may take the form of binding the code vectors in that identified set of code vectors together to form a component vector.

FIG. 2 is a high-level method 200 of reducing a query vector to its component vectors through iterating the evaluation and unbinding of candidate component vectors, consistent with several embodiments of the present disclosure. Method 200 comprises receiving a query vector at operation 202. Operation 202 may include, for example, receiving an output from a neural network, such as an image classifier. The query vector received at operation 202 may represent the neural network's analysis of an image with several objects. While the actual analysis of the neural network may vary in practice, the resulting query vector may resemble what would result if the neural network identified the properties of those objects, created code vectors to represent those properties, bound the code vectors for each object, resulting in a component vector for each object, then superimposed the component vectors, resulting in the query vector. As a result, the superimposed data within the query vector query may be particularly difficult to interpret without reducing the query vector into its component vectors and their code vectors.

Method 200 further comprises generating and evaluating a set of candidate component vectors at operation 204. In some embodiments, operation 204 may resemble operations 104 and 106 of FIG. 1. Operation 204 may, for example, generate a set of several vectors that may be estimates of what the component vectors of the query vector may be. The number of candidate component vectors that are generated and evaluated in a single iteration of operation 204 may be referred to as the width of the process of decoding the query vector that was received in operation 202. This width may vary based on the circumstances of performing method 200. Greater widths may require higher computational resources, as the number of candidate component vectors that are evaluated increases as the width increases. However, increasing the width may also decrease the number of iterations of method 200 that are required to decode the query vector that was received in operation 202. Thus, in use cases in which computing resources are particularly low, a lower width may be used. However, in use cases in which computing resources are particularly high or the available time to decode the vector is low, a greater width may be used.

The nature of the generation and evaluation of the candidate component vectors in operation 204 may vary based on the nature of the query vector and on the use case. For example, in a brute-force method, code vectors in each codebook that was used to train the model that output the query vector may be combined with code vectors in each other codebook, resulting a set of candidate component vectors that are a binding of a code vector from each codebook. In some embodiments each code vector in each codebook may be bound with each code vector in each other codebook, resulting in all possible combinations of code vectors. Those candidate component vectors could then be evaluated by calculating the similarity of each candidate component vector to the query vector. A similarity value above a pre-established similarity threshold may imply that the associated candidate component vector should be identified as an accurate component vector.

As another example, candidate component vectors could be generated as estimated component vectors based on information derived from the query vector. Examples of this process may be referred to as random sampling and random sparsification, and are discussed above. The candidate component vectors created in this example may each then be analyzed through a resonator circuit, as is also discussed above. In some embodiments, each candidate component vector could be evaluated simultaneously in a dedicated resonator circuit. If any of those resonator circuits outputs a set of code vectors for a candidate component vector that are sufficiently similar to a code vector in their corresponding codebook, that candidate component vector may be identified as an accurate component vector.

Upon completing the evaluation of the candidate component vectors, an accurate component vector is identified in operation 206. This identification may signify a confidence that the accurate component vector actually represents a component vector that is superimposed into the query vector. Thus, removing the identified accurate component vector from the query vector would result in a reduced query vector that represented a superposition of all other component vectors in the query vector that was received in operation 202.

Thus, method 200 proceeds to unbundle the identified accurate component vector in operation 208. Operation 208 may include, for example, subtracting each element of the component vector from elements of the input query vector. Operation 206 may yield an output vector, referred to as a “reduced” vector.

Method 200 further comprises evaluating whether the query vector has been reduced to zero in operation 210. A query vector may be reduced to zero if a sufficient percentage of the values of the query vector are 0. For example, if the query vector contains 5,000 dimensions, and thus, 5,000 values, operation 210 may include determining the percentage of those 5,000 values that are 0. This percentage may be referred to herein as a reduction percentage. That reduction percentage may then be compared to a reduction percentage threshold. If the reduction percentage is below the reduction percentage threshold, the query vector would not be considered to be reduced to zero. If, however, the reduction percentage is not below the reduction percentage threshold, the query vector would be considered reduced to zero.

Being reduced to zero signifies that the accurate component vector that was most-recently unbundled from the query vector at operation 208 was the last remaining component vector within the query vector. In other words, reducing a query vector to zero suggests that the query vector was so similar to the accurate component vector that subtracting the accurate component vector from the query vector effectively results in no further information in the query. However, a query vector not being reduced to zero signifies that further component vectors are superimposed into the query vector, and thus that the accurate component vector that was most-recently unbundled from the query vector at operation 208 was not the last remaining component vector within the query vector.

For this reason, if the reduced vector is determined, in operation 210, to not be reduced to zero, method 200 further comprises establishing, in operation 212, the reduced query vector (i.e., the query vector that resulted from the unbundling in operation 208) as a new query vector. For the purposes of method 200, this new query vector may replace the query vector that was received in operation 202. For example, if the query vector that was received in operation 202 coded the properties of five objects within an image, the new query vector established in the first iteration of operation 212 may code the properties of four of those objects. The properties of the fifth object, in this example, would be coded by the accurate component vector that was unbundled from the query vector in operation 208.

Thus, method 200 continues by generating and evaluating, in operation 204, new candidate component vectors for this new query vector. Method 200 may continue, in fact, by repeating operations 204-210 for the new query vector. Further, operations 204-212 may be repeatedly iterated until all candidate component vectors have been unbundled from the query vector and the query vector is reduced to zero in operation 210. After determining that the query vector has been reduced to zero in operation 210, method 200 ends in operation 214.

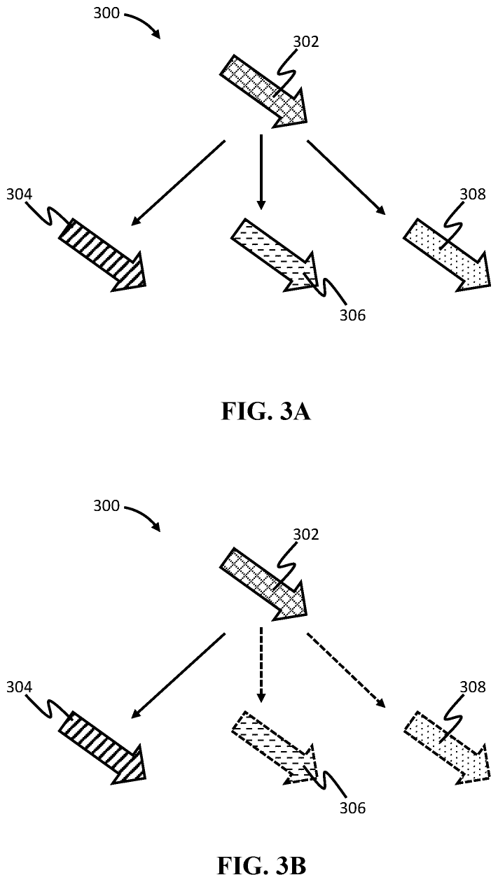

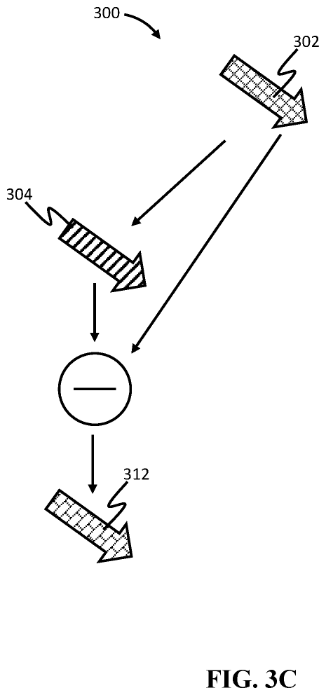

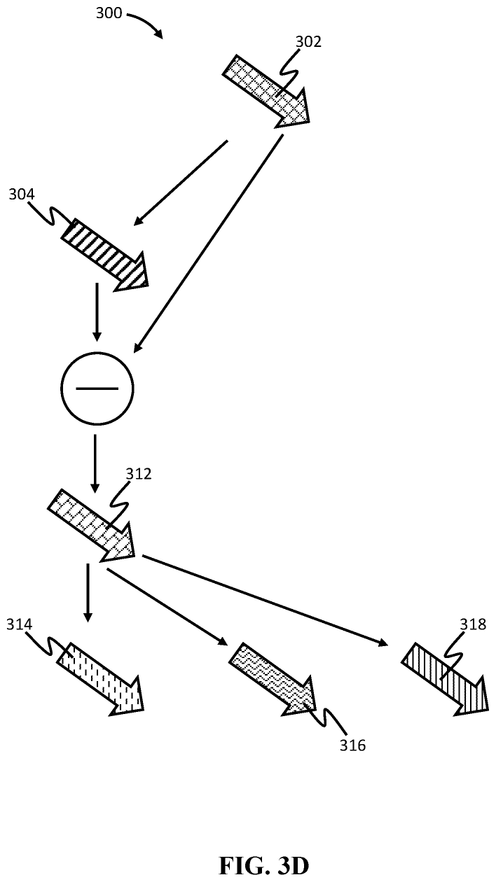

FIGS. 3A-3D illustrate vectors at various stages in an example process of a step of decoding a query vector. As such, the examples depicted in FIGS. 3A-3D may be part of a larger process of decoding a query vector; for example, FIGS. 3A-3D show a query vector being reduced into a reduced query vector. This process may be performed multiple times (in other words, through multiple decoding steps) to continue to reduce the query vector until it is reduced to zero. Further, the example depicted in FIG. 3A is not necessarily the start of the reduction process. For example, the example depicted in FIG. 3A may actually occur after several iterations of a process resembling operations 204-212 in FIG. 2, for example.

Throughout the following description of FIGS. 3A-3D, reference is made to an illustrative example describing query vector 302 as an output vector from an image classifier.

For example, an image of a dog in front of a house may be submitted to the image classifier, and the image classifier may output a query vector as a result. Such an output vector may represent useful data, such as features of objects identified by the classifier. In particular, the output vector may be a superposition (essentially a sum or combination) of a number of individual vectors, referred to as “component vectors.” Many of these component vectors may represent individual objects detected and/or identified in an image by the image classifier. For example, one component vector may include details regarding the dog in the image, such as the position of the dog, the fact that the classifier has identified the dog as a dog, boundaries of the dog within the image, colors of the dog, etc. However, the fact that the output vector effectively binds the individual code vectors that contain all that data into a single vector may mean that this useful data is essentially unintelligible until the output vector is “decoded,” or reduced into component vectors and code vectors that make up those component vectors. Thus, systems and methods consistent with the present disclosure are provided to enable enhanced decoding of such query vectors. This decoding process can be considered an intermediate step between submitting the image to the image classifier and acting based upon the results of the classification. For example, a system configured to open a gate upon a vehicle approaching may take an image from a camera and submit the image to an image classifier. The image classifier may output a query vector, which can be decoded into component vectors and code vectors via systems and methods consistent with the present disclosure. The component vectors and code vectors can then be sent to a system which can determine whether the image classifier has detected a vehicle approaching the gate (as one of the identified component vectors may correspond to a vehicle in the image).

FIG. 3A depicts a block diagram 300 at a stage of generating multiple candidate component vectors, consistent with several embodiments of the present disclosure. Diagram 300 includes query vector 302. In some instances, query vector 302 may be an output vector received from a neural network, such as an image classifier. In such instances, query vector 302 may be received via operation 202 of method 200, described above with reference to FIG. 2. In some instances, query vector 302 may be a partially reduced vector. For example, an output vector from a neural network may have been reduced via operation 208 of method 200, described above with reference to FIG. 2, resulting in query vector 302.

Vector 302 may be formatted as a dense vector or a sparse vector. The format of vector 302 may affect how various candidate component vectors, discussed in further detail above, are generated. However, the overall stages shown in FIGS. 3A-3D may apply to query vector 302 in either format.

Candidate component vectors 304, 306, and 308 are created as estimates of what actual component vectors of query vector 302 may be. The method of generating candidate component vectors 304, 306, and 308 may depend both on the structure of query vector 302 and the circumstances of the use cases in which vector 302 is being decoded. For example, where computing resources and time are not limiting factors, candidate component vectors 304, 306, and 308 may be generated as part of a brute-force effort to generate all possible combinations of code vectors in the codebooks with which the classifier that created query vector 302 was trained. In other use cases, candidate component vectors may be created for analysis with a resonator circuit and may be created based off information derived from vector 302 (for example, through random tie breaking or random sparsification). Thus, the generation of candidate component vectors 304-308 can be performed in a manner substantially similar to operation 104 of method 100, discussed above with reference to FIG. 1, and operation 204 of method 200, discussed above with reference to FIG. 2.

Candidate component vectors 304-308 can be evaluated before selecting one or more candidate component vector that exhibits a high likelihood of being very similar to a component vector of query vector 302. This evaluation process may resemble the processes discussed with respect to operation 106 of FIG. 1 and operation 204 of FIG. 2.

FIG. 3B depicts block diagram 300 at a stage of selecting a candidate component vector from various candidates, consistent with several embodiments of the present disclosure. Once candidate component vectors 304-308 have been generated (depicted in FIG. 3A) and evaluated, candidate component vector 304 has been identified as an accurate component vector, similar to the process discussed with respect to operation 108 of FIG. 1 and operation 106 of FIG. 2.

FIG. 3C depicts block diagram 300 at a stage of unbundling the selected component vector from query vector 302, consistent with several embodiments of the present disclosure. As shown in FIG. 3C, component vector 304 is unbundled from vector 302 to yield a reduced vector 312. This unbundling can be performed in a manner substantially similar to, for example, operation 208 of method 200, discussed above with reference to FIG. 2. The unbundling may be performed on the individual values of query vector 302 on an element-by-element basis. In some instances, vector 302 may have been produced by means of superposition other than addition or by means other than by superposition. Further, rather than subtraction, other types of vector reduction may be performed.

Notably, even after the unbundling depicted in FIG. 3C, reduced vector 312 is still referred to herein as a query vector because it may be suspected of representing the properties of multiple component vectors (i.e., representing a superposition of multiple component vectors). This would not be true if query vector 312 had been reduced to zero, as discussed in relation to operation 210 of FIG. 2.

FIG. 3D depicts block diagram 300 at a stage of generating further candidate component vectors, consistent with several embodiments of the present disclosure. As shown in FIG. 3D, once reduced vector 312 is produced by subtracting candidate component vector 304 from vector 302, further candidate component vectors 314, 316, and 318 (collectively, “candidate component vectors 314-318”) are generated. FIG. 3D's candidate component vectors 314-318 may be generated from reduced vector 312 in a substantially similar manner to how candidate component vectors 304-308 may be generated from vector 302.

The process resulting in the stages depicted in FIGS. 3A-3D can be repeated until a reduced vector is created from an unbundling operation that has reduced the vector to zero (i.e., that has resulted in a vector that has a very high percentage of values (e.g., 99.99%) that are equal to zero). This may constitute decoding vector 302 into its components, enabling usage of data represented by vector 302. For example, each selected component of vector 302 (e.g., candidate component vector 304) may represent a discrete object in an image analyzed by an image classifier, and the code vectors that make up those component vectors may represent the properties of those objects.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as improved superimposed vector decoding code 490. In addition to block 490, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 490, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

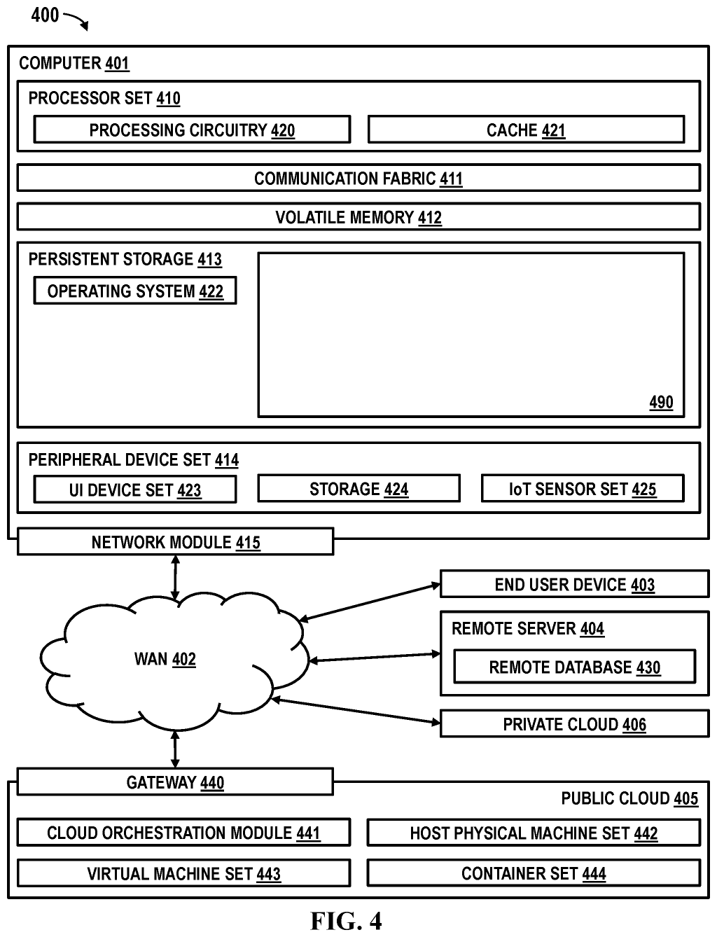

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 490 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 490 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

What is claimed is:

1. A method, comprising:
receiving a composite vector;
generating, a first candidate component vector;
evaluating the first candidate component vector;
selecting, based on the evaluating, the first candidate component vector as an accurate component vector; and
unbundling the first candidate component vector from the composite vector, resulting in a first reduced vector.

2. The method of claim 1, wherein the unbundling includes subtracting the first component vector from the composite vector, resulting in the first reduced vector.

3. The method of claim 1, further comprising:
generating a second candidate component vector; and
evaluating the second candidate component vector.

4. The method of claim 3, further comprising:
generating a third candidate component vector and a fourth candidate component vector;
evaluating the third candidate component vector and the fourth candidate component vector;
selecting, based on the evaluating the fourth candidate component vector, the fourth candidate component vector as an accurate vector; and
unbundling the fourth candidate component vector from the first reduced vector, resulting in a second reduced vector.

5. The method of claim 1, wherein the evaluating the first candidate component vector comprises:
unbinding a set of estimate code vectors from the first candidate component vector; and
calculating a similarity of each estimate code vectors in the set of estimate code vectors to a code vector in a corresponding codebook.

6. The method of claim 1, wherein the generating the first candidate component vector comprises:
identifying a set of codebooks that correspond to the composite vector;
selecting a code vector from each codebook in the set of codebooks; and
binding the selected code vectors into the first candidate component vector.

7. The method of claim 6, wherein evaluating the first candidate component vector comprises calculating a similarity of the first candidate component vector to the composite vector.

8. The method of claim 1, wherein the decoding comprises a series of decoding steps and wherein one decoding step is performed using a resonator.

9. The method of claim 1, wherein the decoding comprises a series of decoding steps and wherein one decoding step is performed using a brute force approach.

10. A system, comprising:
a memory; and
a central processing unit (CPU) coupled to the memory, the CPU configured to:
receive a composite vector;
generate, a first candidate component vector;
evaluate the first candidate component vector;
select, based on the evaluating, the first candidate component vector as an accurate component vector; and
unbundle the first candidate component vector from the composite vector, resulting in a first reduced vector.

11. The system of claim 10, wherein the unbundling includes subtracting the first component vector from the composite vector, resulting in the first reduced vector.

12. The system of claim 10, wherein the CPU is further configured to:
generate a second candidate component vector; and
evaluate the second candidate component vector.

13. The system of claim 12, wherein the CPU is further configured to:
generating a third candidate component vector and a fourth candidate component vector;
evaluating the third candidate component vector and the fourth candidate component vector;
selecting, based on the evaluating the fourth candidate component vector, the fourth candidate component vector as an accurate vector; and
unbundling the fourth candidate component vector from the first reduced vector, resulting in a second reduced vector.

14. The system of claim 10, wherein the evaluating the first candidate component vector comprises:
unbinding a set of estimate code vectors from the first candidate component vector; and
calculating a similarity of each estimate code vectors in the set of estimate code vectors to a code vector in a corresponding codebook.

15. The system of claim 10, wherein the generating the first candidate component vector comprises:
identifying a set of codebooks that correspond to the composite vector;
selecting a code vector from each codebook in the set of codebooks; and
binding the selected code vectors into the first candidate component vector.

16. The system of claim 15, wherein evaluating the first candidate component vector comprises calculating a similarity of the first candidate component vector to the composite vector.

17. The system of claim 10, wherein the decoding comprises a series of decoding steps and wherein one decoding step is performed using a resonator.

18. The system of claim 10, wherein the decoding comprises a series of decoding steps and wherein one decoding step is performed using a brute force approach.

19. A method comprising:
inputting a composite vector into a resonator circuit;
generating a set of estimate code vectors;
creating, for a particular estimate code vector in the set of estimate code vectors, an unbound code vector from the composite vector;
determining that a similarity between the unbound code vector and a set of actual code vectors is above a similarity threshold;
binding, based on the determining, the unbound code vector with a set of other unbound code vectors, resulting in an accurate component vector; and
unbundling the accurate component vector from the composite vector.

20. The method of claim 19, wherein the creating comprises:
selecting, from the set of estimate code vectors, all estimate code vectors that are not the particular estimate code vector; and
unbinding, from the composite vector; each selected estimate code vector.
